(19) United States
(12) Patent Application Publication
(10) Pub. No.: US 2003/0235230 A1
(43) Pub. Date: Dec. 25, 2003

(54) Method and apparatus for mode-locked vertical cavity laser with optimized spectral bandwidth

(75) Inventors: Robert L. Thornton, Los Altos, CA (US); John E. Epler, Milpitas, CA (US)

Correspondence Address: Timothy A. Brisson, Sierra Patent Group, Ltd., P.O. Box 6149, Stateliine, NV, 89449, US

(73) Assignee: Siros Technologies, Inc.

(21) Appl. No.: 09/910,533

(22) Filed: Jul. 20, 2001

Related U.S. Application Data
(63) Continuation-in-part of application No. 09/817,362, filed on Mar. 20, 2001, now Pat. No. 6,628,696.
(60) Provisional application No. 60/263,060, filed on Jan. 19, 2001.

(51) Int. Cl. H01S 3/098; H01S 3/082; H01S 3/08

(52) U.S. Cl. 372/97; 372/96

(57) ABSTRACT

A multi-frequency light source is disclosed. In one aspect, a multi-frequency light source may comprise a gain region defined by a first and second mirror. The gain region may have a resonant mode. The light source may also have an external cavity defined by a third mirror and the second mirror. The external cavity has plurality of resonant modes, including a plurality of contiguous desired modes of operation. The second mirror may be formed such that the multi-frequency light source operates at the desired modes of the external cavity.

### RELATED APPLICATIONS

This application is a continuation in part of U.S. Application Ser. No. 09/817,362, filed Mar. 20, 2001. This application also claims the benefit of U.S. Provisional Applications 60/263,060, filed Jan. 19, 2001; and 60/xxx,xxx, filed Jul. 6, 2001, U.S. Express Mail No. ET161056037US, Attorney Docket No. Siros-031.

### BACKGROUND OF THE INVENTION

I. Field

The present disclosure relates to Vertical Cavity Surface Emission Lasers (VCSELs).

II. Background

Fiber optical networks are becoming increasingly faster and more complex. Key to this expansion are technologies such as Vertical Cavity Surface Emission Lasers (VCSELs) because of their cost.

As is known by those skilled in the art, VCSEL are currently favored over competing technologies such as edge-emitting lasers because VCSELs may be tested while still in wafer form, while edge-emitting laser typically must be dice-cut prior to testing. This is because edge-emitting lasers must be cleaved in order to emit light, while VCSELs do not require cleaving and may emit light while still in wafer form.

However, one challenge to the implementation of VCSELs in modern systems is that current VCSELs may operate well at some wavelengths but not at others. Additionally, some VCSELs may display frequency instability or insufficient power output. Hence, most VCSEL devices are typically employed in applications where exact frequency output is unimportant.

As is appreciated by those skilled in the art, the ultimate limit on emission bandwidth is given by the gain bandwidth of the quantum well region. However, the target response of a given device may often be less than the total emission bandwidth possible for the device. For example, a 16-channel system with 25 GHz spacing requires a total spectral bandwidth of 375 GHz. If the spectral bandwidth of the quantum well structure is greater than 375 GHz, then there is a potential for extraneous channels to be generated outside of the desired spectral band. This is undesirable because of the resulting waste of energy.

Hence, there is a need for a mutlichannel light source that does not suffer from the deficiencies of the prior art.

### SUMMARY

A multi-frequency light source is disclosed. In one aspect, a multi-frequency light source may comprise a gain region defined by a first and second mirror. The gain region may have a corresponding resonant mode. The light source may also have an external cavity defined by a third mirror and the second mirror. The external cavity has plurality of resonant modes, including a plurality of contiguous desired modes of operation. The second mirror may be formed such that the multi-frequency light source operates at the desired modes of the external cavity.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a conceptual diagram of one aspect of a disclosed system;

FIG. 2 is a more detailed conceptual diagram of one aspect of a disclosed system;

FIG. 3 is a plot of the resonant modes of one aspect of a disclosed system;

FIG. 4 is a plot of the resonant bandwidth of one aspect of a disclosed system; and

FIG. 5 is a another plot of the resonant modes of one aspect of a disclosed system.

### DETAILED DESCRIPTION

Persons of ordinary skill in the art will realize that the following description of the present invention is illustrative only and not in any way limiting. Other embodiments of the invention will readily suggest themselves to such skilled persons having the benefit of this disclosure.

The following references are hereby incorporated by reference into the detailed description of the preferred embodiments, and also as disclosing alternative embodiments of elements or features of the preferred embodiment not otherwise set forth in detail above or below or in the drawings. A single one or a combination of two or more of these references may be consulted to obtain a variation of the preferred embodiment described above. In this regard, further patent, patent application and non-patent references, and discussion thereof, cited in the background and/or elsewhere herein are also incorporated by reference into the detailed description with the same effect as just described with respect to the following references:

U.S. Pat. Nos. 5,347,525, 5,526,155, 6,141,127, and 5,631,758;

Wilmsen, Temkin and Coldren, et al., “Vertical Cell Surface Emitting Lasers, 2nd edition;

Ulrich Fiedler and Karl Ebeling, “Design of VCSELs for Feedback Insensitive Data Transmission and External Cavity Active Mode-Locking”, IEEE JSTQE, Vol. 1, No. 2 (June 1995); and

J. Boucart, et al., 1-mW CW-RT Monolithic VCSEL at 1.55 mm, IEEE Photonics Technology Letters, Vol. 11, No. 6 (June 1999).

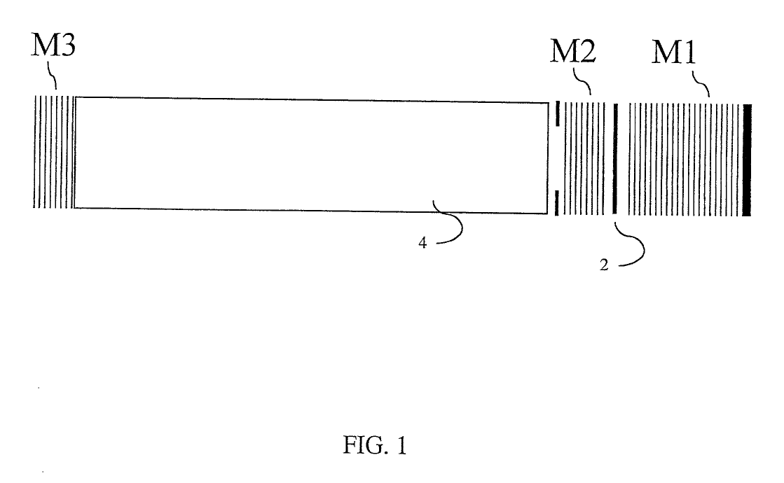

FIG. 1 is a conceptual diagram of a multichannel light source and illustrates a three-mirror composite-cavity VCSEL configured in accordance with the teachings of this disclosure. The light source includes epitiaxially-grown mirrors M1 and M2, and an external mirror M3. In operation, mirror M3 controls frequency spacing between mode-locked modes by way of its distance from M2 and M3 (representing a cavity length L2), and provides output coupling of the laser energy. The combination of these mirrors defines two cavities: the VCSEL resonant cavity 2, or gain cavity 2, defined by M1 and M2; and an external cavity 4 defined by M2 and M3.

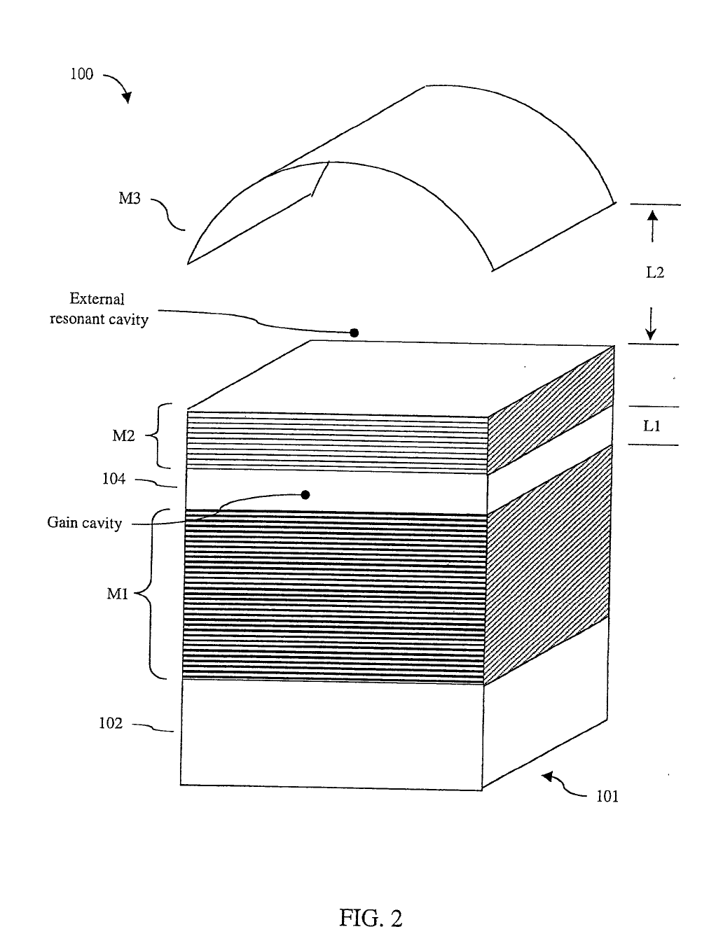

FIG. 2 is a more detailed conceptual diagram of one aspect of a disclosed multifrequency light source 100. The light source 100 may include a VCSEL 101 having a substrate 102 for reflecting light at normal incidence. The substrate 102 may be formed from materials known in the art such as Gas or InP depending on the desired wavelength.

On top of the substrate 102 a mirror M1 is formed. The layers of M1 may be formed epitaxially using techniques known in the art. If the substrate 102 comprises GaAs, then the layers of M1 may be formed from alternating layers of GaAs/InGaAs for use in the wavelength range of 780-980 nm. Alternatively, if the substrate 102 comprises InP, the layers of M1 may formed of alternating layers of InGaAlAs/InP for use in the wavelength range of 1300-1700 nm.

An active layer 104 for amplifying light is then grown on M1. The active layer 104 may comprise a quantum well active layer fashioned from the same materials as M1. The active layer 104 will have a gain response and a nominal peak frequency associated therewith. In one aspect of a disclosed light source, the active layer 104 may have a nominal peak frequency of 1550 nm. The nominal peak frequency are typically functions of variables such as current or temperature.

A mirror M2 may then be grown on the active layer 104 using techniques similar to M1. The active layer 104, combined with mirror layers 102 and M3 comprise a resonant cavity for which can be associated an effective cavity length L1.

The light source 100 may further include a mirror M3 disposed a distance L2 from the upper surface of M2.

A multifrequency light source 100 is thus formed including a VCSEL 101 and an external mirror M3 wherein several alternative designs and variations may be possible. The light source 100 may be described in terms of the distance L1 between mirrors M1 and M2 forming a gain cavity and the distance L2 between mirrors M2 and M3 forming an external cavity.

In general, the cavity length of the external cavity may be greatly extended compared with a conventional VCSEL device. The external cavity may be, e.g., between a few hundred microns and several millimeters, and is particularly preferred around 2-3 mm in physical length for a mode-spacing of 50 GHz. For example, at 50 GHz and for a refractive index n=1 (such as for an air or inert gas filled cavity), then the cavity will have a physical length L2 of about 3 mm, which provides a 3 mm optical path length corresponding to 50 GHz. The actual cavity length to achieve 50 GHz may also depend on the reflective indices of the media between M2 and M3. For example, for a cavity material such as glass, e.g., n=1.5, then the physical length will be around 2 mm to provide the optical path length of 2 mm×1.5=3 mm, again corresponding to a 50 GHz mode spacing.

The distance L2 and thus the cavity length may be increased to reduce the mode-spacing. For example, by doubling the cavity length, e.g., to 4-6 mm, the mode-spacing may be reduced to 25 GHz, or by again doubling the cavity length, e.g., to 8-12 mm, the mode-spacing may be reduced to 12.5 GHz. The mode-spacing may be increased, if desired, by alternatively reducing the cavity length, e.g., by reducing the cavity length to half, e.g., 1-1.5 mm to increase the mode-spacing to 100 GHz. Generally, the mode-spacing may be advantageously selected by adjusting the cavity to a corresponding cavity length. The device of the preferred embodiment may utilize other means for reducing the mode-spacing as understood by those skilled in the art.

This extension of cavity length from that of a conventional VCSEL is permitted by the removal or partial removal of a mirrored reflector surface of the mirror M2 and inclusion of mirror M3. The light source 100 and in particular the mirror M3 may be formed as disclosed in co-pending application No. 09/817,362, filed Mar. 20, 2001, and assigned to the same assignee of the present application, and incorporated by reference as though set forth fully herein.

The extension of the external cavity out to 1.5-15 mm permits a 10-100 GHz mode spacing, since the cavity will support a number of modes having a spacing that depends on the inverse of the cavity length (i.e., c/2 nL, where c is the speed of light in vacuum, n is the refractive index of the cavity material and L is the cavity length). The VCSEL with external cavity device for providing multiple channel signal output according to a preferred embodiment herein is preferably configured for use in the telecom band around 1550 nm, and alternatively with the telecom short distance band around 1300 nm or the very short range 850 nm band. In the 1550 nm band, 100, 50 and 12.5 GHz cavities are of particular interest as they correspond to standard DWDM channel spacings.

The monolithic portion of the light source 100 may be around 15 microns tall when formed on a substrate 100-700 μm thick and preferably comprises a gain medium of InGaAsP or InGaAs and InGaAlAs or In GaAsP or AlGaAs mirrors (or mirrors formed of other materials according to desired wavelengths as taught, e.g., in Wilmsen, Temkin and Coldren, et al., “Vertical Cavity Surface Emitting Lasers, 2nd edition, Chapter 8).

The light source 100 may be formed in a variety of manners. For example, the second mode spacing cavity may be formed by a solid lens of either conventional or gradient index design, and may be formed of glass. When a gradient index lens is used, the index of refraction of the material filling the cavity varies (e.g., decreases) with distance from the center optical axis of the resonant cavity. Such GRIN lens provides efficient collection of the divergent light emitted from the laser cavity. In an embodiment using a GRIN lens, the mirrored surface of mirror M3 may be curved or flat, depending on design considerations.

The mirror M3 may have one or more coatings on its remote surface such that it efficiently reflects incident light emitted from the VCSEL 101 as a resonator reflector, preferably around 1550 nm for the telecom band. The mirror M3 is preferably formed of alternating high and low refractive index materials to build up a high reflectivity, such as alternating quarter-wavelength layers of TiO2/SiO2 or other such materials known to those skilled in the art.

The radius of curvature of the lens may be around the length the second cavity. Emitted radiation from the VCSEL 101 will diverge outward from the gain region substantially be reflected directly back into the gain region when the radius of curvature is approximately the cavity length, or around 2-3 mm for a 50 GHz mode-spacing device.

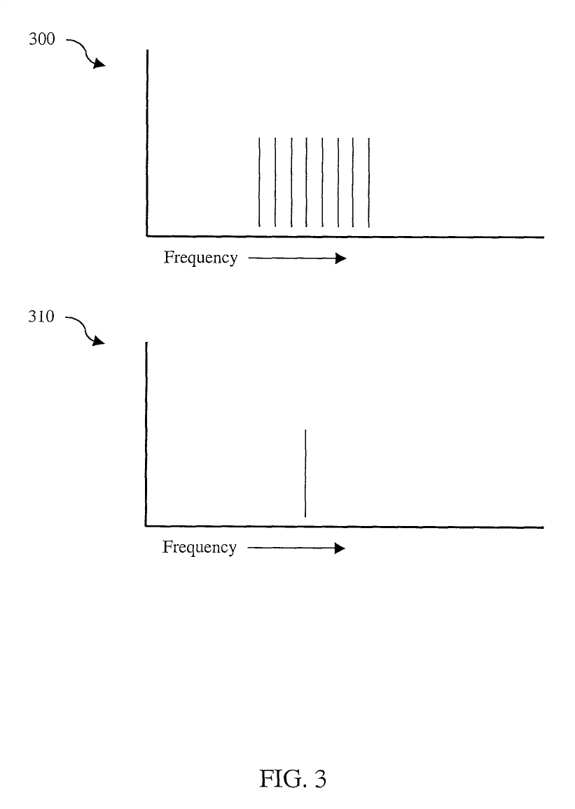

The two cavities of the light source 100 will each have corresponding resonant modes associated therewith, as illustrated in FIG. 3. The resonant modes for the external cavity defined by the distance L2 are shown as plot 300, and corresponding resonant mode plot for the gain cavity defined by the distance L1 is shown as plot 310.

In operation, the cavities provide one or more resonant nodes at optical frequencies for which the roundtrip gain exceeds the loss. For a longer cavity such as the external cavity, the resonant nodes form a comb of frequencies having a separation inversely proportional to the cavity length. For example, for a cavity optical length of 3 mm, the optical spacing of the modes is approximately 50 GHz. The light amplifying active layer will typically have a gain bandwidth of 2-4 THz (2000-4000 GHz). Thus, many such nodes will fit within the gain bandwidth of the gain material.

However, the gain cavity of the VCSEL gain cavity typically has a micron-scale optical length and thus a much greater modal spacing, typically in the multi-THz range. Since L2>>L1, many more resonant modes will occur in the external cavity in a given frequency spectrum than will occur in the gain cavity. In fact in the typical instance, there may be only one resonant mode in the first cavity which falls in the corresponding gain bandwidth of the laser, as is illustrated in FIG. 3.

Thus, typically only one resonance will exist in the gain bandwidth. The breadth of this resonance depends on the values of M2 and M3 and may range from a few GHz to 1 THz.

When the two cavities defined by (M1 and M2) and (M2 and M3) are put together, they must jointly satisfy roundtrip phase boundary conditions for laser operation. If the modes of the second cavity do not overlap with at least one of the modes of the first cavity, then laser emission will not be achieved.

Thus, when combining the fine comb frequencies of an external cavity with the single resonance of a VCSEL gain cavity, lasing may be limited to cavity resonances which lie within the resonant bandwidth of the VCSEL gain cavity. The width of the resonance of the VCSEL cavity may be varied by varying M1 and M2, such that the gain cavity resonance can span multiple external resonances.

Two typical specifications for VCSEL-based systems are channel frequency spacing and number of channels. The product of these two represents the emission bandwidth and is therefore an essential requirement for any VCSEL device.

The response of the device thus depends on the relative reflectivity of the mirrors, the gain response and bandwidth of the amplifying region, and the relationship between the resonances of the gain regions of both cavities.

In one aspect of a disclosed multi-frequency light source, the spectral bandwidth of the light source may be controlled by varying the reflectivity of M2. The reflectivity of M2 may be controlled by altering the number of layer pairs used to form the mirror. As the reflectivity of M2 is decreased, the spectral bandwidth will increase.

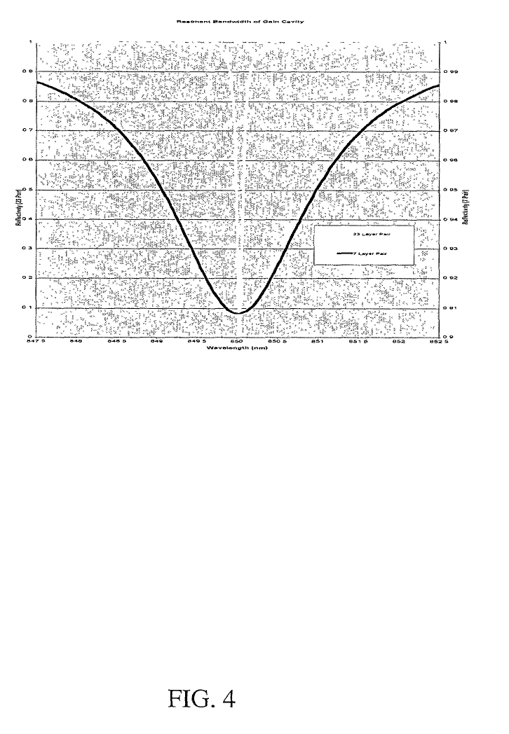

FIG. 4 is plot showing the reflectivity of M2 for two disclosed aspects. In one aspect, M1 comprises a 35 layer-pair mirror and M2 comprises a 7 layer-pair mirror; and in a second aspect, M1 comprises a 35 layer-pair mirror and M2 comprises a 23 layer pair mirror. As will be appreciated from FIG. 4, the 23 layer-pair structure has a resonance width which is more narrow than the 7 layer-pair stack. Since the response of the 23 layer-pair structure is an order of magnitude more narrow than the 7 layer-pair structure, coupling the 7 layer-pair structure with an external cavity will result in a much greater spectral range.

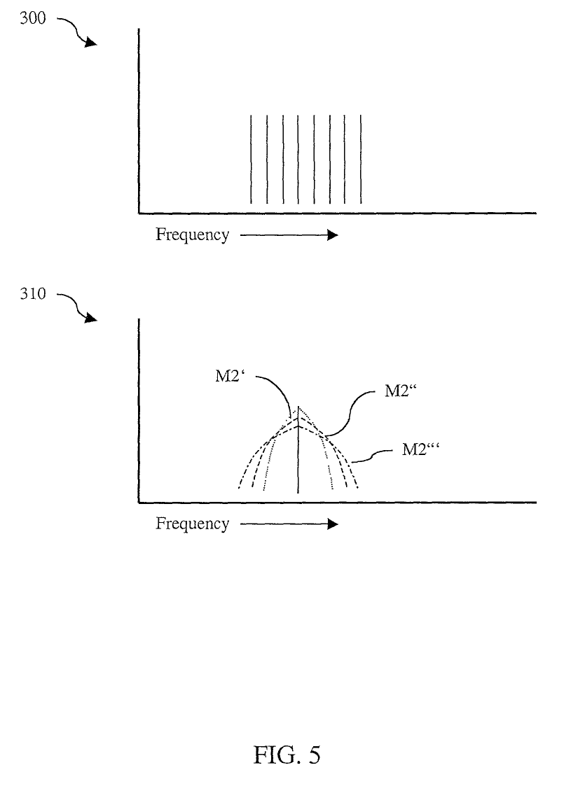

FIG. 5 is a conceptual plot showing how the reflectivity of M1 may be adjusted to achieve mode selectivity. FIG. 5 includes the resonant modes of an external cavity 400 plotted above the resonant mode of a VCSEL gain cavity 410 along a common frequency axis. FIG. 5 further shows how varying the reflectivity of the gain cavity may result in different responses M2′, M2′, and M2′″. By analogy to the electrical arts, by varying the Q of the gain cavity, the resonant bandwidth of the gain cavity may be selected advantageously. As the reflectivity of the mirror is reduced, the resonance flattens out, as in a lower-Q circuit.

As will be appreciated from FIG. 5, by varying the reflectivity of M2, the spectral bandwidth of the gain cavity may be chosen so as to have a predetermined response shape. By varying the response shape of the mirror, the response of the gain cavity may be shaped so as to overlap or intersect one or more of the resonant modes of the external cavity. The reflectivity of M2 may be chosen such that the resonant mode of the gain cavity is substantially equal in frequency to one or more of the modes of the external cavity.

Thus, given a plurality of resonant modes in an external cavity, the response of the gain cavity may be varied so as to select one or more of the external cavity's modes. For example, if it is desired to lase at a particular frequency, the response of M2 may be configured to overlap only a single selected external cavity resonance, and any overlap should be of a low enough amplitude such that none of the immediately adjacent modes, or “neighbour” modes, will operate.

Or, if it is desired to have multiple frequencies lase, the reflectivity of M2 may be lowered to select multiple resonances of the external cavity. The desired resonant modes of the external cavity may be characterized as a contiguous plurality of desired modes of operation interspersed in frequency between undesired modes of operation. Thus, by utilizing the advantageous disclosed methods, one can control the reflectivity of the mirror M2 to select desired modes of operation.

It is contemplated that the reflectivity of M3 may be adjusted to compensate for the reduced reflectivity of M2. For example, the reflectivity or other characteristics of M3 might be varied based upon how much output power is desired.

The previous description of various embodiments, which include preferred embodiments, is provided to enable any person skilled in the art to make or use the present invention. The various modifications to these embodiments will be readily apparent to those skilled in the art, and the generic principles defined herein may be applied to other embodiments without the use of the inventive faculty. Thus, the present disclosure is not intended to be limited to the embodiments shown herein but is to be accorded the widest scope consistent with the principles and novel features disclosed herein.

What is claimed is:

1. A light source comprising:
a gain region defined by a first and second mirror, said gain region having a corresponding response shape;
an external cavity defined by a third mirror and said second mirror, said external cavity having a plurality of resonant modes; and
wherein said second mirror is formed such that said response shape of said gain region selects at least two of said plurality of modes.

2. The light source of claim 1, wherein said first mirror and the gain region is fabricated for use in the wavelength range of approximately 780-790 nm.

3. The light source of claim 1, wherein said first mirror and the gain region is fabricated for use in the wavelength range of approximately 1300-1700 nm.

4. The light source of claim 1, wherein said gain region response shape has a nominal peak wavelength of approximately 1550 nm.

5. The light source of claim 1, wherein said external cavity is greatly extended in length compared to said gain region.

6. The light source of claim 1, wherein the length of said external cavity has a length of approximately 2-3 mm.

7. The light source of claim 1, wherein said plurality of resonant modes have a mode spacing of approximately 100 GHz.

8. The light source of claim 1, wherein said plurality of resonant modes have a mode spacing of approximately 50 GHz.

9. The light source of claim 1, wherein said external cavity is filled with air and has a length of approximately 3 mm.

10. The light source of claim 1, wherein said external cavity comprises glass and has a length of approximately 2 mm.

11. The light source of claim 1, wherein the length of said external cavity has a length of approximately 4-6 mm.

12. The light source of claim 1, wherein said plurality of resonant modes have a mode spacing of approximately 25 GHz.

13. The light source of claim 1, wherein the length of said external cavity has a length of approximately 8-12 mm.

14. The light source of claim 1, wherein said plurality of resonant modes have a mode spacing of approximately 12.5 GHz.

15. The light source of claim 1, wherein said light source is configured for use in the wavelength range of 1550 nm.

16. The light source of claim 15, wherein said external cavity is configured to provide mode spacing corresponding to standard DWDM channel spacings.

17. The light source of claim 16, wherein said external cavity provides a mode spacing of 12.5 GHz.

18. The light source of claim 16, wherein said external cavity provides a mode spacing of 50 GHz.

19. The light source of claim 16, wherein said external cavity provides a mode spacing of 100 GHz.

20. The light source of claim 1, wherein said third mirror is configured to reflect incident light in the 1550 nm telcom band.

21. The light source of claim 1, wherein said third mirror has a radius of curvature equal to the length of said external cavity.

22. The light source of claim 1, wherein the relative reflectivity values of said first, second, and third mirrors, and the length of said external cavity are configured to reduce the number of lasing modes to at least two.

23. The light source of claim 1, wherein the properties of said second mirror may be adjusted so as to select a predetermined plurality of said external cavity resonant modes.

24. The light source of claim 1, wherein said plurality of resonant modes comprises a contiguous plurality of desired modes of operation interspersed in frequency between undesired modes of operation.

25. The light source of claim 24, wherein said desired modes of operation are selected such that said response shape of said gain region does not overlap in frequency with either of said undesired modes of operation.

26. The light source of claim 24, wherein said desired modes of operation are selected such that said response shape of said gain region overlaps in frequency with either of said undesired modes of operation to a degree insufficient to enable lasing.

27. A light source comprising:
a gain region defined by a first and second mirror, said gain region having a corresponding response shape;
an external cavity defined by a third mirror and said second mirror, said external cavity having a plurality of resonant modes including a desired mode of operation and at least one undesired mode of operation; and
wherein said second mirror is formed such that said response shape of said gain region selects a predetermined subset of said desired modes of operation while not selecting said at least one undesired mode of operation.

28. The light source of claim 27, wherein said first mirror and the gain region is fabricated for use in the wavelength range of approximately 780-790 nm.

29. The light source of claim 27, wherein said first mirror and the gain region is fabricated for use in the wavelength range of approximately 1300-1700 nm.

30. The light source of claim 27, wherein said gain region response shape has a nomninal peak wavelength of approximately 1550 nm.

31. The light source of claim 27, wherein said external cavity is greatly extended in length compared to said gain region.

32. The light source of claim 27, wherein the length of said external cavity has a length of approximately 2-3 mm.

33. The light source of claim 27, wherein said plurality of resonant modes have a mode spacing of approximately 100 GHz.

34. The light source of claim 27, wherein said plurality of resonant modes have a mode spacing of approximately 50 GHz.

35. The light source of claim 27, wherein said external cavity is filled with air and has a length of approximately 3 mm.

36. The light source of claim 27, wherein said external cavity comprises glass and has a length of approximately 2 mm.

37. The light source of claim 27, wherein the length of said external cavity has a length of approximately 4-6 mm.

38. The light source of claim 27, wherein said plurality of resonant modes have a mode spacing of approximately 25 GHz.

39. The light source of claim 27, wherein the length of said external cavity has a length of approximately 8-12 mm.

40. The light source of claim 27, wherein said plurality of resonant modes have a mode spacing of approximately 12.5 GHz.

41. The light source of claim 27, wherein said light source is configured for use in the wavelength range of 1550 nm.

42. The light source of claim 41, wherein said external cavity is configured to provide mode spacing corresponding to standard DWDM channel spacings.

43. The light source of claim 42, wherein said external cavity provides a mode spacing of 12.5 GHz.

44. The light source of claim 42, wherein said external cavity provides a mode spacing of 50 GHz.

45. The light source of claim 42, wherein said external cavity provides a mode spacing of 100 GHz.

46. The light source of claim 27, wherein said third mirror is configured to reflect incident light in the 1550 nm telcom band.

47. The light source of claim 27, wherein said third mirror has a radius of curvature equal to the length of said external cavity.

48. The light source of claim 27, wherein the relative reflectivity values of said first, second, and third mirrors, and the length of said external cavity are configured to reduce the number of lasing modes to at least two.

49. The light source of claim 27, wherein the properties of said second mirror may be adjusted so as to select a predetermined plurality of said external cavity resonant modes.

50. The light source of claim 27, wherein said plurality of resonant modes comprises a contiguous plurality of desired modes of operation interspersed in frequency between undesired modes of operation.

51. The light source of claim 50, wherein said desired modes of operation are selected such that said response shape of said gain region does not overlap in frequency with either of said undesired modes of operation.

52. The light source of claim 50, wherein said desired modes of operation are selected such that said response shape of said gain region overlaps in frequency with either of said undesired modes of operation to a degree insufficient to enable lasing.

53. A light source comprising:
a gain region defined by a first and second mirror, said gain region having a corresponding response shape;
an external cavity defined by a third mirror and said second mirror, said external cavity having a plurality of resonant modes including a contiguous plurality of desired modes of operation interspersed in frequency between undesired modes of operation; and
wherein said gain region is formed such that said response shape of said gain region selects said desired mode of operation while not overlapping in frequency with said undesired modes of operation.

54. The light source of claim 53, wherein said first mirror and the gain region is fabricated for use in the wavelength range of approximately 780-790 nm.

55. The light source of claim 53, wherein said first mirror and the gain region is fabricated for use in the wavelength range of approximately 1300-1700 nm.

56. The light source of claim 53, wherein said gain region response shape has a nominal peak wavelength of approximately 1550 nm.

57. The light source of claim 53, wherein said external cavity is greatly extended in length compared to said gain region.

58. The light source of claim 53, wherein the length of said external cavity has a length of approximately 2-3 mm.

59. The light source of claim 53, wherein said plurality of resonant modes have a mode spacing of approximately 100 GHz.

60. The light source of claim 53, wherein said plurality of resonant modes have a mode spacing of approximately 50 GHz.

61. The light source of claim 53, wherein said external cavity is filled with air and has a length of approximately 3 mm.

62. The light source of claim 53, wherein said external cavity comprises glass and has a length of approximately 2 mm.

63. The light source of claim 53, wherein the length of said external cavity has a length of approximately 4-6 mm.

64. The light source of claim 53, wherein said plurality of resonant modes have a mode spacing of approximately 25 GHz.

65. The light source of claim 53, wherein the length of said external cavity has a length of approximately 8-12 mm.

66. The light source of claim 53, wherein said plurality of resonant modes have a mode spacing of approximately 12.5 GHz.

67. The light source of claim 53, wherein said light source is configured for use in the wavelength range of 1550 nm.

68. The light source of claim 67, wherein said external cavity is configured to provide mode spacing corresponding to standard DWDM channel spacings.

69. The light source of claim 68, wherein said external cavity provides a mode spacing of 12.5 GHz.

70. The light source of claim 68, wherein said external cavity provides a mode spacing of 50 GHz.

71. The light source of claim 68, wherein said external cavity provides a mode spacing of 100 GHz.

72. The light source of claim 53, wherein said third mirror is configured to reflect incident light in the 1550 nm telcom band.

73. The light source of claim 53, wherein said third mirror has a radius of curvature equal to the length of said external cavity.

74. The light source of claim 53, wherein the relative reflectivity values of said first, second, and third mirrors, and the length of said external cavity are configured to reduce the number of lasing modes to at least two.

75. The light source of claim 53, wherein the properties of said second mirror may be adjusted so as to select a predetermined plurality of said external cavity resonant modes.

76. The light source of claim 53, wherein said desired modes of operation are selected such that said response shape of said gain region does not overlap in frequency with either of said undesired modes of operation.

77. The light source of claim 53 wherein said desired modes of operation are selected such that said response shape of said gain region overlaps in frequency with either of said undesired modes of operation to a degree insufficient to enable lasing.

78. A light source comprising:
a gain region defined by a first and second mirror, said gain region having a corresponding response shape;
an external cavity defined by a third mirror and said second mirror, said external cavity having a plurality of resonant modes including a contiguous plurality of desired modes of operation interspersed in frequency between undesired modes of operation; and
wherein said gain region is formed such that said response shape of said gain region selects said plurality of desired modes of operation such that said undesired modes of operation do not operate.

79. The light source of claim 78, wherein said first mirror and the gain region is fabricated for use in the wavelength range of approximately 780-790 nm.

80. The light source of claim 78, wherein said first mirror and the gain region is fabricated for use in the wavelength range of approximately 1300-1700 nm.

81. The light source of claim 78, wherein said gain region response shape has a nominal peak wavelength of approximately 1550 nm.

82. The light source of claim 78, wherein said external cavity is greatly extended in length compared to said gain region.

83. The light source of claim 78, wherein the length of said external cavity has a length of approximately 2-3 mm.

84. The light source of claim 78, wherein said plurality of resonant modes have a mode spacing of approximately 100 GHz.

85. The light source of claim 78, wherein said plurality of resonant modes have a mode spacing of approximately 50 GHz.

86. The light source of claim 78, wherein said external cavity is filled with air and has a length of approximately 3 mm.

87. The light source of claim 78, wherein said external cavity comprises glass and has a length of approximately 2 mm.

88. The light source of claim 78, wherein the length of said external cavity has a length of approximately 4-6 mm.

89. The light source of claim 78, wherein said plurality of resonant modes have a mode spacing of approximately 25 GHz.

90. The light source of claim 78, wherein the length of said external cavity has a length of approximately 8-12 mm.

91. The light source of claim 78, wherein said plurality of resonant modes have a mode spacing of approximately 12.5 GHz.

92. The light source of claim 78, wherein said light source is configured for use in the wavelength range of 1550 nm.

93. The light source of claim 92, wherein said external cavity is configured to provide mode spacing corresponding to standard DWDM channel spacings.

94. The light source of claim 93, wherein said external cavity provides a mode spacing of 12.5 GHz.

95. The light source of claim 93, wherein said external cavity provides a mode spacing of 50 GHz.

96. The light source of claim 93, wherein said external cavity provides a mode spacing of 100 GHz.

97. The light source of claim 78, wherein said third mirror is configured to reflect incident light in the 1550 nm telcom band.

98. The light source of claim 78, wherein said third mirror has a radius of curvature equal to the length of said external cavity.

99. The light source of claim 78, wherein the relative reflectivity values of said first, second, and third mirrors, and the length of said external cavity are configured to reduce the number of lasing modes to at least two.

100. The light source of claim 78, wherein the properties of said second mirror may be adjusted so as to select a predetermined plurality of said external cavity resonant modes.

101. The light source of claim 78, wherein said desired modes of operation are selected such that said response shape of said gain region does not overlap in frequency with either of said undesired modes of operation.

102. The light source of claim 78, wherein said desired modes of operation are selected such that said response shape of said gain region overlaps in frequency with either of said undesired modes of operation to a degree insufficient to enable lasing.
